(19) United States
(12) Patent Application Publication
(10) Pub. No.: US 2006/0120838 A1
(43) Pub. Date: Jun. 8, 2006

(54) Device and method for facilitating loading/unloading of a rail goods transporter

(76) Inventor: Peter Berglund, Valkens Waard (NL)

Correspondence Address: Merchant & Gould, PO Box 2903, Minneapolis, MN, 55402-0903, US

(21) Appl. No.: 10/527,014

(22) PCT Filed: Aug. 26, 2003
(86) PCT No.: PCT/SE03/01315

§ 371 Date: Sep. 28, 2005

(30) Foreign Application Priority Data
Sep. 9, 2002 (SE) 0202653-2

(51) Int. Cl. B65F 9/00

(52) U.S. Cl. 414/373

(57) ABSTRACT

Device and method for facilitating loading/unloading of goods from a goods wagon (1) comprising least one load-carrying unit (5), and two wagon portions (10). The wagon portions are provided with means for transport on rail, and the load-carrying unit (5) is separable from the wagon portions (10) on at least one end, and is movable to facilitate loading/unloading of the load-carrying unit (5). The load-carrying unit (5) is provided with at least one slide foot that slides over an according slide belt during lateral displacement of at least one end of the load-carrying unit.

### FIELD OF THE INVENTION

This invention generally relates to goods wagon loading/unloading, and more particularly to a device and a method that can facilitate loading/unloading of railway goods wagons on railway stations.

### BACKGROUND OF THE INVENTION

Due to a number of reasons, including environmental issues, economical benefit and political decisions, a transfer of goods transports from roads to railways is presently going on in Europe. The largest drawback with goods transport on railways compared to truck transports on the public road net is that the loading/unloading of the goods on the railway stations is costly, time consuming and complicated. Mostly, the goods on the train wagons is unloaded from the train wagons to trucks, to be forwarded the last few kilometres by truck to the destination.

Until now, train stations that facilitate the loading/unloading of goods have been very expensive, with low capacity. Since there are only a few train stations that can handle considerable amounts of goods, the distances that the goods must be carried on trucks, from the train station to the destination, are very long.

To add to the problem with goods transports on rail in Europe, many of the present goods wagons are limited to a speed of 60 km/h, which chokes the railway systems so severely that most goods transports are prohibited from using the rails during daytime. The main reason for the limited speed of present goods wagons is the wheel size; in order to increase the height and length of the load compartment, the wheel sizes are chosen to be as small as possible. Small wheels have low top speed, due to the increased centrifugal forces they are subjected to at high speeds.

WO 96/11829 discloses a goods wagon, which has one end of the load-carrying unit pivotable around an axis whereas the other end comprises means for performing the pivoting action. The means for the pivoting action include members in form of wheels or rolls. This design has got some severe drawbacks: the use of a pivoting axis in one end of the load carrying unit means that only one end of the load carrying unit opens to facilitate loading/unloading of the load-carrying unit. Furthermore, the use of wheels or rolls leads to very high point or line forces on the ground on which the pivoting takes place. The forces are large enough to make it necessary to reinforce the ground around the track where the pivoting is to take place. Such ground reinforcement is expensive.

Lohr Industries recently presented a “swing-tray” wagon, where the load-carrying unit (or “tray”) is pivoted (or “swinged”) around a central pivoting axis, in order to facilitate loading/unloading of the goods. This design solves the above-mentioned problems; by opening both ends of the load carrying unit, the loading/unloading of the goods is much simplified, and the ground around the tracks is not affected at all. This design has, however, got other severe drawbacks; the height of the load is limited by the inherent fact that the load-carrying unit is mounted in fixed height bearings in the centre of the wagon and hence can not be lowered. This in turn leads to the loading height being unnecessarily high, which makes loading/unloading operations difficult. Using smaller wheels on the bogies of the wagon can reduce this problem, but, as mentioned earlier, smaller wheels leads to reduced top speed, which is very disadvantageous from a number of views.

### SUMMARY OF THE INVENTION

As can be understood from the above, there is clearly a need for a goods wagon that facilitates loading/unloading of the goods, that uses the full height of the track system for the load and is able to travel at high speed. Until now, this was only accomplished by using a device according to WO-96/11829, but this design has as mentioned the severe drawback that it exerts a very high pressure on the ground on which the pivoting takes place. This pressure is only handled with a reinforcement of the ground surrounding the railway track, but such reinforcement is very costly.

The present invention aims to reduce or solve the above mentioned problems by providing a goods wagon that facilitates loading/unloading of the goods, that have big enough wheels to be able to travel at high speed. In the same time it has a load compartment that is high enough to allow full height trucks and trailers to be loaded in the load compartment. The problem is solved by providing a goods wagon that is separated in two or more pieces, comprising at least one load carrying unit and two wagon portions with wheels engaging the rails. The load-carrying unit is releasable from the wagon portions and is able to move away from the wagon portions by means of a slide foot that slides over a sliding belt. This movement of the load-carrying unit opens the ends of the unit for loading/unloading of the inner compartment of the unit, and the slide foot distributes the force from the mass of the load enough to avoid demands on reinforced grounds at the railway stations.

### BRIEF DESCRIPTION OF THE DRAWINGS

FIG. 1 is a side elevation view of a the central parts of a goods wagon according to the present invention

FIG. 2 is a longitudinal diagrammatic view of one end piece of the load-carrying unit in the goods wagon according to the present invention.

FIG. 3 is a partly cut-away perspective view of a load ramp attached to the end piece of the load carrying unit in the goods wagon according to the present invention.

FIG. 4 is a top plan view showing the load-carrying unit according to the present invention in the loading/unloading position.

### DETAILED DESCRIPTION OF A PREFERRED EMBODIMENT

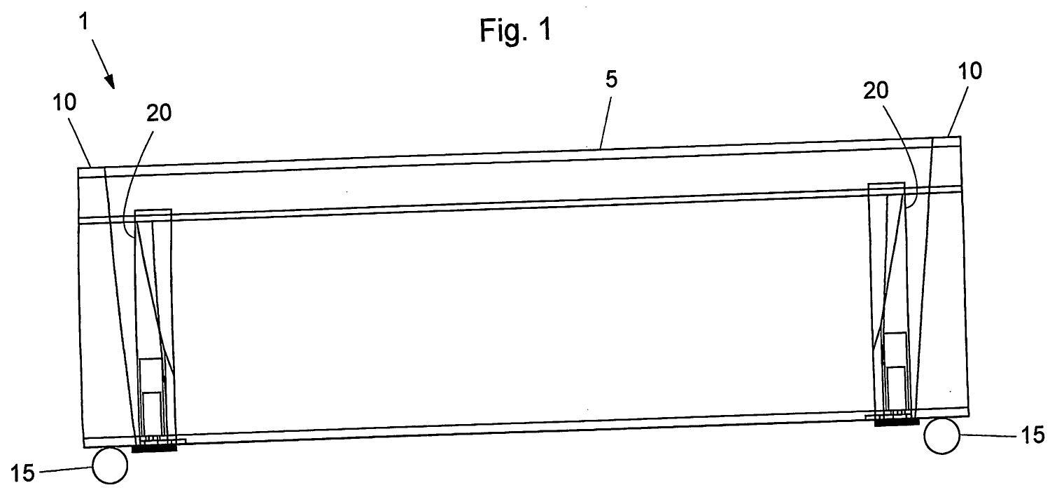

FIG. 1 shows a central portion of a goods wagon 1, comprising a load-carrying unit 5 and two wagon portions 10, on which wagon portions a number of wheels 15 are rotatably mounted. The wheels 15 engage rails (not shown) as the train set is travelling. The load carrying unit 5 is coupled to the wagon portion 10. Furthermore, two load/unload ramps 20 and raising/lowering means 25 for the load-carrying unit 5 are shown. In the position shown in FIG. 1, the load-carrying unit 5 is coupled to the wagon portions 10 by releasable fastening means (not shown).

The loading/unloading ramps 20 are in closed (raised) position, and the raising/lowering means 25 are in the lowered position, meaning that the entire weight of the load-carrying unit 5 and its load is carried by the wagon portions 10.

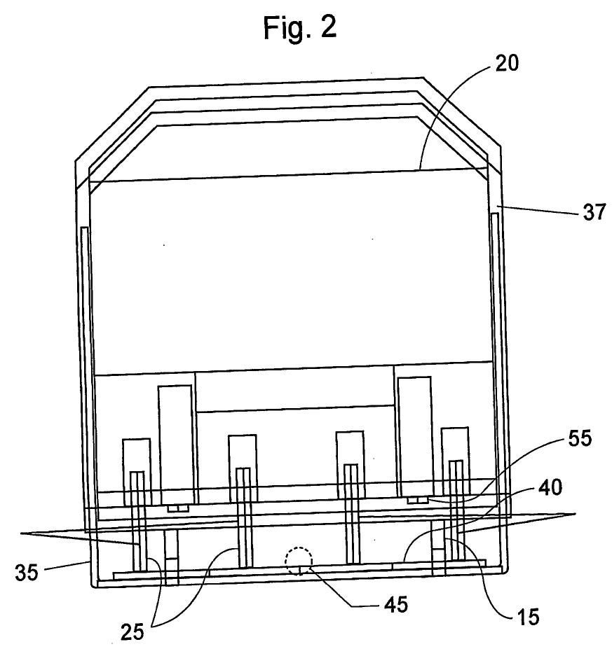

FIG. 2 shows an end portion 30 of the load-carrying unit 5, a slide belt 35 housed in a compartment 37 in the side walls of the load-carrying unit 5, and a slide foot 40, that can be raised or lowered by the raising/lowering means 25. A drive wheel 45, engaging a high friction or toothed web (not shown) on the slide belt 35, is provided to deliver the power that is required to make the slide foot 40 and the slide belt 35 slide relative one another. The driving action of the slide belt 35 relative to the slide foot 40 can be performed in other ways, e.g. by hydraulic or pneumatic linear drives, without deviating from the scope of the invention.

The slide belt 35 is loaded by elastic means (e.g. a spring or the like, not shown) in the compartment 37 that will make the slide belt 35 be retracted into the compartment 37 when it is not needed.

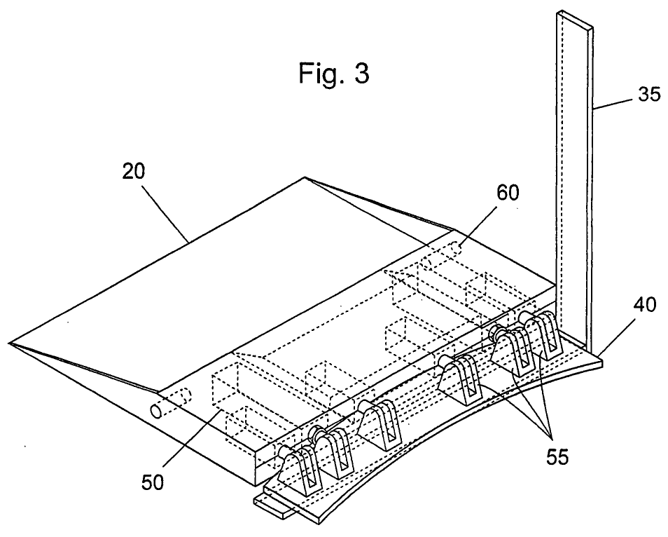

FIG. 3 shows a design of the load/unload ramps 20, including the raising/lowering means 25 (reference numeral, see FIG. 2), ramp actuating means 50, and hinging means 55. The hinging means 55 provide a hinging action between the ramp 20 and the load-carrying unit 5. Furthermore, the slide belt 35, and the slide foot 40 are shown. On the sides of the ramp 20, two holes 60 are provided, that serve as parts of a locking mechanism that locks the ramp 20 in the closed (raised) position.

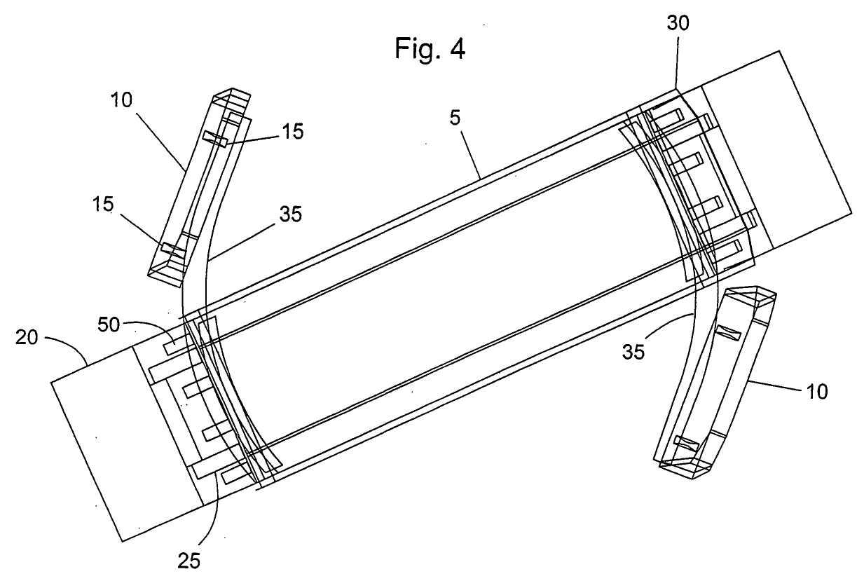

FIG. 4 shows the function of the goods wagon 1, and will be more clearly described in the following with reference to the above reference numerals.

In order the move the load-carrying unit 5 from the wagon portions 10, the raising/lowering means 25 are actuated to lower the slide foot 40, and hence the slide belt 35, in contact with the ground and hence raise the load-carrying unit 5. The raising of the load-carrying unit 5 inactivates the locking means between the load-carrying unit 5 and the wagon portions 10. As the load-carrying unit 5 has been raised, and hence on both ends rests upon the slide foot 40 and the slide belt 35, the drive wheels 45 are activated to induce sliding motion between the slide foot 40 and the slide belt 35. This sliding action will move the load-carrying unit 5 away from the wagon portions 10, leaving the ends of the unit 5 open for loading/unloading of the unit 5.

The movement of the load carrying unit 5 can be chosen depending on the status of the railway station; if the ground is paved on one side of the track only, the load carrying unit 5 can be moved laterally with respect to the length axis of the goods wagon 1. If both sides are paved, it is more advantageous to induce a pivoting motion to the load-carrying unit 5, with a virtual, central pivoting point, as shown in FIG. 4.

In order to reduce the friction between the slide belt 35 and the slide foot 40, the slide belt 35 is preferably covered with, on the surface pointing towards the slide foot 40, or manufactured from, some kind of low friction material (e.g. PolyTetraFluorEthylene, PTFE, which is sold under the trademark Teflon®). For the same reason, the slide foot 40 can be provided with upwardly bent end portions, not unlike a ski.

As can be understood, the slide foot 40 will travel on a path describing a radius equal to half the length of the load-carrying unit 5 when the load carrying unit 5 is pivoted as in FIG. 4. Preferably, both the slide foot 40 and the slide belt 35 are formed with the same radius.

For the case with lateral movement of the load carrying unit, the slide foot 40 and the slide belt 35 can be straight.

In practice, it might not be necessary to have various slide foot/slide belt designs for pivoting and lateral displacements, respectively, as the radius of the slide belt/slid foot will be large.

As mentioned, the slide belt 35 is prior to the movement housed in a compartment 37 in the side of the load-carrying unit 5. During the movement, the slide belt 35 is drawn out from the compartment 37, and is pressed towards the ground by the slide foot 40.

When the movement has reached the desired amount, preferably so that the load-carrying unit 5 is well clear from the wagon portions 10, the drive wheels are inactivated and the load-carrying unit 5 is lowered, so that the load-carrying unit 5 rests on its entire length on the ground. During this sequential step, the slide belt 35 could rest on the ground or be pulled into the compartment 37 in the side of the load-carrying unit 5.

When the pivoting is completed, the loading/unloading ramps 20 are lowered by the ramp actuating means 50 to allow the load-carrying unit 5 to be loaded or unloaded. When the loading/unloading process is complete, the ramps 20 are raised and the raising means 25 are actuated so that the load carrying unit is raised. The drive wheels are activated in the opposite direction compared to the abovementioned sequence, leading to sliding action between the slide foot and the slide belt, which leads to the load-carrying unit 5 being moved back towards the wagon portions 10. During the “back-moving”, the slide belt 35 is pulled back into the compartment 37 in the sidewall of the load-carrying unit 5. As the load-carrying unit 5 has been moved back to the wagon portions 10, the load-carrying unit 5 is lowered to engage the locking means that lock the load-carrying unit 5 to the wagon portions 10.

The load-carrying units 5 can be manufactured from metals or alloys in form of bars, beams or sheets. A more preferred material is however composite materials including different types of plastic (e.g. polyester and epoxy resins) and reinforcing fibres (e.g. glass fibres, carbon fibres, aramid fibres, boron fibres or the like).

1. Device for facilitating loading/unloading of goods from a goods wagon (1) comprising least one load-carrying unit (5), and two wagon portions (10) and means for locking together the load-carrying unit (5) and the wagon portions (10), which wagon portions are provided with means for transport on rail, said load-carrying unit (5) being separable from the wagon portions (10) on at least one end, and is movable to facilitate loading/unloading of the load-carrying unit (5), wherein the load-carrying unit (5) is provided with at least one slide foot that slides over a slide belt during lateral displacement of at least one end of the load-carrying unit, where the means for raising the load-carrying unit (5) are provided for inactivating the locking means.

2. Device according to claim 1, wherein the slide foot (40) is provided with upwardly bent ends.

3. Device according to claim 1, wherein the slide belt (35) is housed in compartments (37) in side walls of the load-carrying unit (5).

4. Device according to claim 1, wherein the slide belt (35) is covered with, or manufactured from, low friction material

5. Device according to claim 1, wherein the slide belt is covered with low friction plastic.

6. Device according to claim 5, wherein the low friction plastic covering the drive belt is of PTFE type (e.g. TEFLON®).

7. Device according to claim 1, wherein the load-carrying unit (5) is manufactured from composite plastics.

8. Device according to claim 1, wherein the load-carrying unit (5) is provided with ramps (20) that facilitate loading/unloading of goods.

9. Device according to claim 1, wherein the load-carrying unit (5) is raised and lowered by means (25) connecting the load-carrying unit (5) with the slide foot (40).

10. Device according to claim 1, wherein one slide foot (40) with according slide belt (35) is provided at each end of the load carrying unit (5).

11. Device according to claim 1, wherein ramp (s) are hingedly received in at least one end of the load-carrying unit (5).

12. Method for facilitating loading/unloading of goods from a goods wagon (1) comprising least one load-carrying unit (5), and two wagon portions (10) and means for locking said load-carrying unit (5) and said wagon portions (10), which wagon portions are provided with means for transport on rail, said load-carrying unit (5) being separable from the wagon portions (10) on at least one end, and is movable to facilitate loading/unloading of the load-carrying unit (5), wherein the ends of the load-carrying unit (5) is moved laterally, thereby inactivating the locking means, by means of at least one slide foot that slides over an corresponding slide belt during lateral displacement of at least one end of the load-carrying unit.

13. Method according to claim 12, wherein the ends of the load-carrying unit (5) are slid to impose a pivoting motion of the load-carrying unit (5) around a central, virtual pivot axis situated between the wagon portions (10).

14. Method according to claim 12, wherein the ends of the load-carrying unit (5) are moved laterally from the wagon portions (10), imposing a lateral movement of the load unit with respect to a virtual line connecting the wagon portions (10).
